(19) United States
(12) Patent Application Publication
(10) Pub. No.: US 2007/0094398 A1
(43) Pub. Date: Apr. 26, 2007

(54) SYSTEM AND METHOD FOR AUTOMATICALLY DOWNLOADING NETWORK CONTENT

(75) Inventor: YI-HSIU CHOU, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,573

(22) Filed: Aug. 25, 2006

(30) Foreign Application Priority Data
Oct. 21, 2005 (CN) 200510100563.9

(51) Int. Cl. G06F 15/16

(52) U.S. Cl. 709/227; 709/217

(57) ABSTRACT

A method for automatically downloading network content, comprising steps of receiving user preferences; downloading network content; determining whether the network content corresponds with the user preferences; and transmitting the network content to a client if the network content corresponds with the user preferences.

### FIELD OF THE INVENTION

The invention relates to a system and method for downloading content, and particularly to a system and method for automatically downloading network content.

### DESCRIPTION OF THE RELATED ART

Due to rapid development and expansion of the Internet, network devices are increasingly popular, and so requirements for the network device are ever growing. An important criterion in assessing a network device is the number of functions or services it provides.

Nowadays, many network devices are on-line all the time, but are often in an idle state. If a user wants to browse network content online, he or she has to access the Internet via his or her network device. Moreover, if the user wants to browse the latest content, which is updated periodically (such as stock, weather, and so on), he or she has to get online with the network device to retrieve the latest content each time, which is quite time-consuming and bothersome. Therefore, there exists a need for the network device to automatically collect network content.

### SUMMARY OF THE INVENTION

An exemplary embodiment of the present invention provides a system for automatically downloading network content. The system includes a user database, a content downloading module, a determining module, and a transmitting module. The user database saves user preferences. The content downloading module downloads network content according to the user preferences. The determining module determines whether the network content corresponds with the user preferences. The transmitting module transmits the corresponding network content to a client according to the user preferences.

An exemplary embodiment of the present invention provides a method for automatically downloading network content. The method includes steps of receiving user preferences; downloading network content; determining whether the network content corresponds with the user preferences; and transmitting the network content to a user terminal if the network content corresponds with the user preferences.

Other advantages and novel features will become more apparent from the following detailed description of preferred embodiments when taken in conjunction with the accompanying drawings, in which:

### BRIEF DESCRIPTION OF THE DRAWINGS

FIG. 1 is a schematic diagram illustrating an application environment of the invention;

FIG. 2 is a block diagram illustrating a system for automatically downloading network content of an exemplary embodiment of the invention; and

FIG. 3 is a flowchart of a method for automatically downloading network content of an exemplary embodiment of the invention.

### DETAILED DESCRIPTION OF THE INVENTION

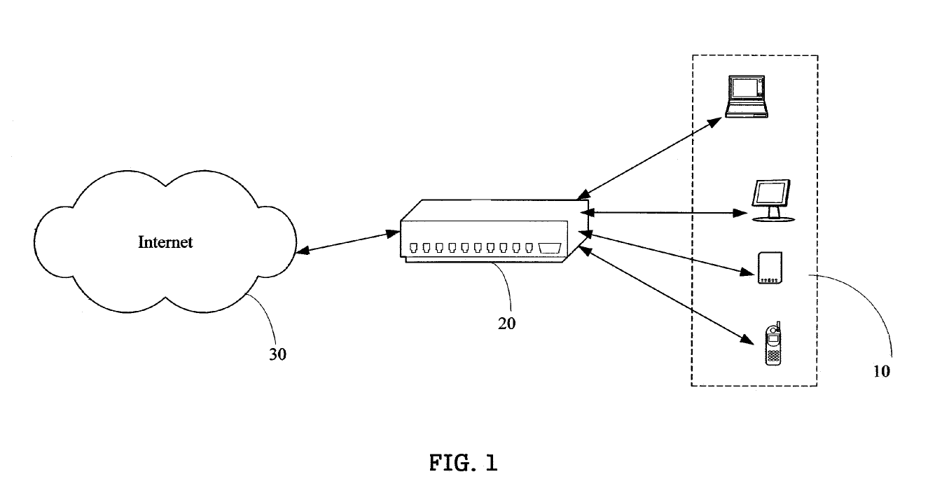

FIG. 1 is a schematic diagram illustrating an application environment of an exemplary embodiment of the invention. A client 10 is connected to the Internet 30 via a network device 20, and downloads network content from the Internet 30. In this embodiment, the client 10 may be a personal computer, a telephone, a mobile phone, and the like.

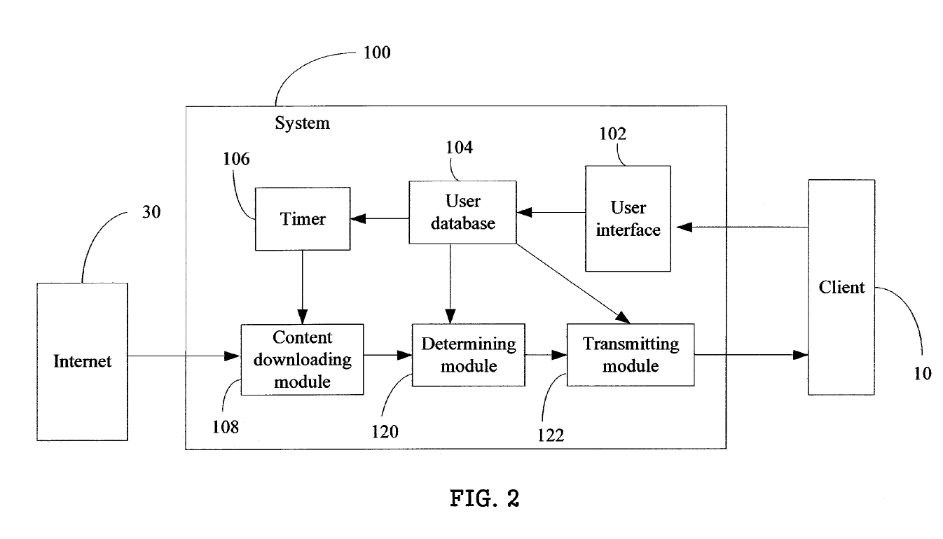

FIG. 2 is a block diagram illustrating a system for automatically downloading network content according to the exemplary embodiment of the present invention. The system 100 is installed in the network device 20. The system 100 includes a user interface 102, a user database 104, a timer 106, a content downloading module 108, a determining module 120, and a transmitting module 122.

The user interface 102 receives user preferences from the client 10. In the exemplary embodiment, the user preferences include types of the network content, such as stock reports, weather, music, and so on, allowing the user to freely select the network content. The user preferences also include an updating period of the network content, for example, the user may select one day as the updating period of the weather, or one hour as the updating period of the stock reports, and so on. The user preferences further include selection criteria of the network content, for instance, the user may select cloudy as the selection criterion for the weather information, or an upper or lower price limit of a particular stock as the selection criterion for the stock reports, and so on. The user preferences still further include selection of transmission tools of the network content, such as Email, Web, short message service, and instant message.

The user database 104 saves the user preferences received from the user interface 102.

The timer 106 sets a time period, and enables the content downloading module 108 to download network content after the time period has elapsed.

The content downloading module 108 downloads network content according to the user preferences, and transmits the network content to the determining module 120.

The determining module 120 determines whether the network content corresponds with the user preferences, and transmits the network content to the transmitting module 122 if the network content does correspond with the user preferences.

The transmitting module 122 transmits the network content received from the determining module 120 to the client 10. In the exemplary embodiment, the transmitting module 122 detects whether the client 10 connects to the network device 20, if yes, the transmitting module 122 transmits the network content to the client 10 directly; if not, the network content is temporarily saved in the network device 20, and the transmitting module 122 transmits the network content to the client 10 when the client 10 is connecting to the network device 20. In this embodiment, the client 10 may be a personal computer, and the transmitting module 122 may use Email as the transmission tool to transmit the network content to the client 10. In other embodiments, the client 10 may be a telephone, a mobile phone, and so on, the transmitting module 122 may use a web, a short message service, or instant messaging as the transmission tool to transmit the network content to the client 10, and so on.

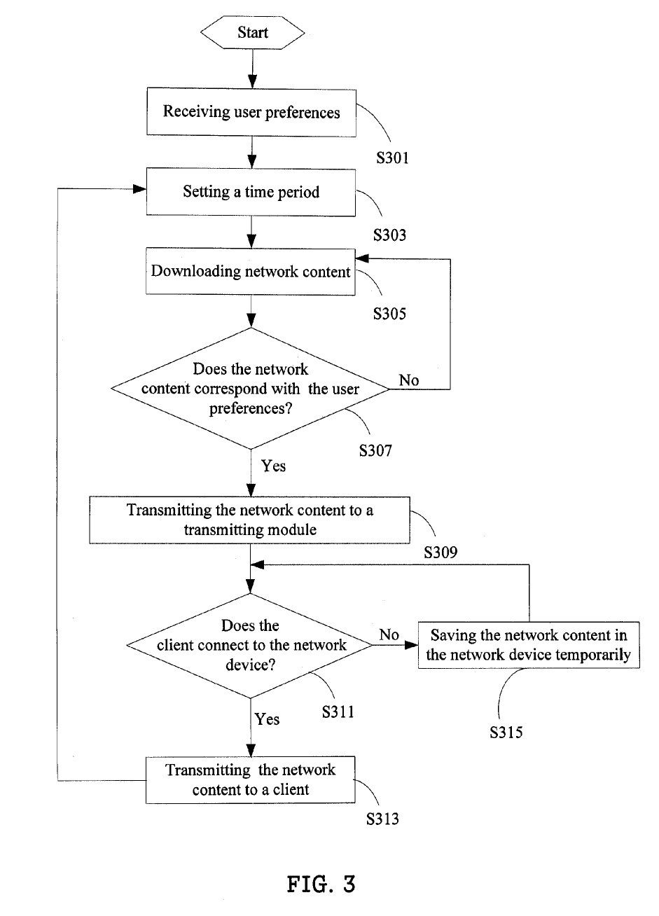

FIG. 3 is a flowchart of a method for automatically downloading network content from the Internet of another exemplary embodiment of the present invention.

In step S301, the system 100 receives the user preferences via the user interface 102, and stores the user preferences in the user database 104. In the exemplary embodiment, the user preferences include types of the network content, updating time of the network content, the selection criteria of the network content, the transmission tools of the network content, and so on.

In step S303, the timer 106 sets a time period according to the user preferences. In the exemplary embodiment, the time period is the updating period of the network content saved in the user database 104.

In step S305, the content downloading module 108 downloads the network content from the Internet according to the user preferences after the time period has elapsed. In the exemplary embodiment, the content downloading module 108 downloads the network content according to the types of the network content saved in the user database 104.

In step S307, the determining module 120 receives the network content,and determines whether the network content corresponds with the user preferences.

In step S309, the determining module 120 transmits the network content to the transmitting module 122 if the network content corresponds to the user preferences.

In step S311, the transmitting module 122 detects whether the client 10 is connecting to the network device 20. If yes, the process proceeds to step S313; if not, the process proceeds to step S315.

In step S313, the transmitting module 122 transmits the network content to the client 10 via a transmission tool of the user database 104. In the exemplary embodiment, the transmission tool includes E-mail, web, short message service, and instant messaging. After step S313, the process returns to step S303, the timer 106 sets a next time period according to the user preferences.

In step S315, the network content is temporarily saved in the network device 20. Then the process returns to step S311.

In step S307, if the network content does not correspond with the user preferences, the process proceeds to step S305.

While embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A system for automatically downloading network content, comprising:
a user database for saving user preferences received from a client;
a content downloading module for downloading network content from the Internet according to the user preferences;
a determining module for determining whether the network content corresponds with the user preferences; and
a transmitting module for transmitting the network content to the client according to the user preferences if the network content corresponds with the user preferences.

2. The system as claimed in claim 1, further comprising a timer for counting a time period, and enabling the content downloading module to download the network content after the time period has elapsed.

3. The system as claimed in claim 1, further comprising a user interface for receiving the user preferences from the client.

4. The system as claimed in claim 1, wherein the user preferences comprise types of the network content.

5. The system as claimed in claim 1, wherein the user preferences comprise an updating period of the network content.

6. The system as claimed in claim 1, wherein the user preferences comprise selection criteria of the network content.

7. The system as claimed in claim 1, wherein the user preferences comprise a plurality of transmission tools of the network content.

8. The system as claimed in claim 7, wherein the transmission tool comprises E-mail.

9. The system as claimed in claim 7, wherein the transmission tool comprises a short message service.

10. The system as claimed in claim 7, wherein the transmission tool comprises a Web.

11. The system as claimed in claim 7, wherein the transmission tool comprises an instant messenger.

12. A method for automatically downloading network content, comprising steps of:
receiving user preferences;
downloading network content;
determining whether the network content corresponds with the user preferences; and
transmitting the network content to a client if the network content corresponds with the user preferences.

13. The method as claimed in claim 12, wherein if the network content does not correspond with the user preferences, returning to step of downloading network content.

14. The method as claimed in claim 12, further comprising:
setting a time period according to the user preferences; and
downloading the network content from the Internet after the time period has elapsed.

15. The method in claim 12, wherein the step of receiving user preferences further comprises a step of receiving types of the network content.

16. The method as claimed in claim 12, wherein step of receiving user preferences further comprises a step of receiving an updating period of the network content.

17. The method as claimed in claim 12, wherein step of receiving user preferences further comprises a step of receiving selection criteria of the network content.

18. The method as claimed in claim 12, wherein step of receiving user preferences further comprises a step of receiving transmission tools of the network content.

19. A method for automatically downloading network content from the Internet, comprising the steps of:
establishing network connection between the Internet and a network device used to provide network connection for a client to access the Internet;
retrieving user preferences from said client to said network device;
downloading network content from the Internet to said network device based on said user preferences regardless of activity of said client; and
transmitting said downloaded network content to said client if said client connects to said network content.

20. The method as claimed in claim 19, further comprising the step of setting a time period according to said user preferences to perform said downloading step periodically.
